(19) United States
(12) Patent Application Publication
(10) Pub. No.: US 2010/0125898 A1
(43) Pub. Date: May 20, 2010

(54) USE OF AUTHENTICATION INFORMATION TO MAKE ROUTING DECISIONS

(75) Inventors: Yannick Dubuc, Coquitlam (CA); Michael Rozhavsky, Vancouver (CA); Randy Lee, Wake Forest, NC (US)

Correspondence Address: MICHAEL A DESANCTIS;HAMILTON DESANCTIS & CHA LLP, FINANCIAL PLAZA AT UNION SQUARE, 225 UNION BOULEVARD, SUITE 305, LAKEWOOD, CO, 80228, US

(73) Assignee: FORTINET, INC., Sunnyvale, CA (US)

(21) Appl. No.: 12/641,307

(22) Filed: Dec. 17, 2009

Related U.S. Application Data
(63) Continuation of application No. 11/774,575, filed on Jul. 7, 2007.
(60) Provisional application No. 60/820,945, filed on Jul. 31, 2006.

(51) Int. Cl. H04L 9/32; G06F 21/00; G06F 15/173

(52) U.S. Cl. 726/7; 709/238; 726/15

(57) ABSTRACT

Methods and systems for utilizing authentication attributes to determine how to direct traffic flows are provided. According to one embodiment, a program storage device readable by a network device associated with a service provider is provided. The program storage device tangibly embodies a program of instructions executable by a processor of the network device to perform method steps for authenticating users and establishing appropriate service sessions. An end user from whom a connection request is received is caused to be prompted for login credentials. The received login credentials are then caused to be authenticated by an authentication server. Responsive to successful authentication, a service session is established for the end user and customer separation is maintained among the multiple customers by creating a routing entry, according to which subsequent packets associated with the service session are routed, based on authentication attributes returned by the authentication server.

### CROSS-REFERENCE TO RELATED APPLICATIONS

This application is a continuation of U.S. patent application Ser. No. 11/774,575, filed on Jul. 7, 2007, which claims the benefit of U.S. Provisional Application No. 60/820,945 filed on Jul. 31, 2006, both of which are hereby incorporated by reference in their entirety for all purposes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2006-2009, Fortinet Inc.

### BACKGROUND

1. Field

Embodiments of the present invention relate generally to computer networks, managed services, user authentication and packet routing decisions. More particularly, embodiments of the present invention relate to distinguishing among users based on authentication results to assist with traffic forwarding/routing.

2. Description of the Related Art

Service providers, such as Managed Security Service Providers MSSPs and Internet Service Providers (ISPs), and network providers, such as satellite network providers and shipping line network providers, have a need to provide separation of customer security services. These companies have an existing network infrastructure that supports their customers' data needs anywhere in the world and are now working to provide additional value added services for the benefit of their customers including, but not limited to, security services, such as antivirus, antispam, web filtering and intrusion prevention.

One issue facing service providers and network providers wishing to provide value added services, such as security services, is that their customers have access into their infrastructure from anywhere in the world and from any network in the world. Most of these security providers and network providers do not use Virtual Private Networks (VPNs) to create customer separation, but rather provide an authentication interface to authorize access to their services based on various authentication protocols, such as Remote Authentication and Remote Authentication Dial-in User Service Protocol (RADIUS). As a result, on the Transmission Control Protocol (TCP)/Internet Protocol (IP) side of things, these users cannot be distinguished from one another.

### BRIEF DESCRIPTION OF THE SEVERAL VIEWS OF THE DRAWINGS

Embodiments of the present invention are illustrated by way of example, and not by way of limitation, in the figures of the accompanying drawings and in which like reference numerals refer to similar elements and in which:

FIG. 1 illustrates an example Managed Security Service Provider (MSSP) environment in which various embodiments of the present invention may be implemented.

FIG. 2 is a simplified, high-level flow diagram illustrating an authentication procedure for a dynamic policy routing according to one embodiment of the present invention.

FIG. 3 is an exemplary edge device in which embodiments of the present invention may be practiced.

FIG. 4 is a block diagram conceptually illustrating interaction among various functional units of a network gateway with a remote client and a RADIUS server in accordance with one embodiment of the present invention.

FIG. 5 is a block diagram conceptually illustrating a simplified RADIUS database in accordance with one embodiment of the present invention.

FIG. 6 is a block diagram conceptually illustrating a RADIUS packet and attribute format.

### SUMMARY

Methods and systems are described for utilizing authentication attributes to determine how to direct traffic flows. According to one embodiment, a system is provided, which includes an authentication server and a network. The authentication server includes an augmented authentication database including routing information for multiple users. The routing information is for use in connection with facilitating routing of traffic flows associated with the users to appropriate virtual networks associated with a network accessible by the users. The network includes a network device fronting the network and coupled in communication with the authentication server. The network device includes a storage device and one or more processors. The storage device has stored therein one or more authentication handler routines operable to authenticate users and establish appropriate service connections for authenticated users. The one or more processors are coupled to the storage device and are operable to execute the one or more authentication handler routines. Login credentials of a user are authenticated against the augmented authentication database responsive to receiving, by the one or more authentication handler routines, a request on behalf of the user to access a service provided by a first virtual network of the network. Responsive to successful authentication of the login credentials, routing information associated with the authenticated user is received from the authentication server by the one or more authentication handler routines. Finally, a connection to the service is established for the authenticated user by creating a routing entry within a routing table of the network device based on the received routing information.

In accordance with another embodiment, a program storage device readable by a network device associated with a service provider is provided. The program storage device tangibly embodies a program of instructions executable by one or more processors of the network device to perform method steps for authenticating users and establishing appropriate service sessions for authenticated users. The method involves receiving a connection request from an end user of one of multiple customers for which the service provider delivers services. The end user is then prompted for login credentials. Responsive to receiving the login credentials, the login credentials are caused to be authenticated by an authentication server. Responsive to receiving an indication of successful authentication of the login credentials from the authentication server, a service session is established for the end user and customer separation is maintained among the multiple customers by creating a routing entry corresponding to an address associated with the connection request based on one or more authentication attributes associated with the indication and subsequent packets associated with the service session are routed in accordance with the routing entry.

Other features of embodiments of the present invention will be apparent from the accompanying drawings and from the detailed description that follows.

### DETAILED DESCRIPTION

Apparatus and methods are described for making routing decisions based on user authentication results. According to one embodiment, information returned in a RADIUS authentication result (i.e., a RADIUS Access-Accept packet) may be used to create an appropriate routing entry appropriate for the authenticated user. For example, the RADIUS authentication database may be augmented with information regarding a virtual network and/or network interface to which traffic flow associated with authenticated users should be routed, which is returned to the authentication requestor (e.g., a gateway) with successful authentication requests. The gateway may then establish a routing entry for the authenticated user's source IP address that causes subsequent traffic from the user's source IP address to be forwarded to an appropriate output interface of the gateway as indicated by the authentication result.

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, the steps may be performed by a combination of hardware and software.

Embodiments of the present invention may be provided as a computer program product, which may include a machine-readable medium having stored thereon instructions, which may be used to program a computer (or other electronic devices) to perform one or more processes in accordance with embodiments of the present invention.

The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

While, for convenience, embodiments of the present invention are described with reference to a particular authentication protocol, i.e., RADIUS, the present invention is equally applicable to various other current and future authentication protocols or user authentication services. For example, it is contemplated that the authentication procedure described herein for supporting dynamic policy routing could use directory access protocols, such as Lightweight Directory Access Protocol (LDAP), or other authentication protocols, such as Terminal Access Controller Access Control System (TACACS), extended TACACS (XTACACS), TACACS+, Diameter, Microsoft Windows Active Directory (AD) server, Novel eDirectory, RSA SecurID, Xauth, user authentication using an internal database, Extensible Authentication Protocol (EAP), Microsoft Windows 2000 Internet Authentication Service (IAS), Kerberos protocol, Security Assertion Markup Language (SAML), client certificates, Single Sign-On logon tickets, and the like.

In addition, for sake of brevity, embodiments of the present invention are described with reference to a specific edge device (i.e., a FortiGate™ firewall) that establishes firewall policies and/or routing entries specifically for the source IP address of authenticated users. Nevertheless, the present invention is equally applicable to various other networking devices, edge appliances, gateways, firewalls and the like. For example, even a generic router is thought to benefit from use of embodiments of the present invention for certain applications.

Finally, for purposes of illustration, embodiments of the present invention are described in the context of an MSSP; however, the methods described herein are not limited to such an environment. Distinguishing among users and making routing decisions based on authenticated credentials is also thought to be useful in other network contexts.

### Terminology

Brief definitions of terms and phrases used throughout this application are given below.

The term “authentication” generally refers to the process of determining whether someone is in fact who he or she claims to be. In private and public computer networks, including the Internet, authentication is commonly done through logon passwords. Other commonly used credentials include passphrases, smart cards, Personal Identification Numbers (PINs), tokens, biometrics and certificates.

The phrase “co-location network” generally refers to the provision of space for customers' telecommunications and/or networking equipment on the service provider's premises. For example, a Web site owner could place the site's own computer servers on the premises of an Internet service provider (ISP). Or, an ISP could provide network connections, such as Internet, leased lines, etc. to several subscribers by housing the subscribers' servers together in a server room of the ISP, for example.

The terms “connected” or “coupled” and related terms are used in an operational sense and are not necessarily limited to a direct connection or coupling.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

If the specification states a component or feature “may”, “can”, “could”, or “might” be included or have a characteristic, that particular component or feature is not required to be included or have the characteristic.

The term “responsive” includes completely or partially responsive.

The phrase “virtual domain” or “VDOM” generally refers to a separately configurable and manageable set of interfaces of a network security device. VDOMs enable a network gateway or firewall to function as multiple independent units. According to one embodiment, with VDOM functionality enabled a network security device may provide separate security domains that allow separate zones, user authentication, firewall policies, routing and Virtual Private Network (VPN) configurations.

The phrase “virtual local area network” or the acronym “VLAN” generally refers to a logical grouping of workstations, clients and/or servers on one or more local area networks (LANs) regardless of where they are physically located. For example, endpoints within a particular VLAN may be logically grouped together as a result of being associated with the same department of an enterprise, being used by the same types of end users, having the same primary application, having common security requirements and the like. Each logical grouping of devices is configured (using management software, for example) to allow them to communicate among each other as if they were within the same broadcast domain, when in fact they are located on a number of different LAN segments.

The phrase “virtual network” generally refers to a computer network in which topology has nothing to do with physical connections between participating nodes. Virtual network is intended to encompass both the concepts of VDOMs and VLANs.

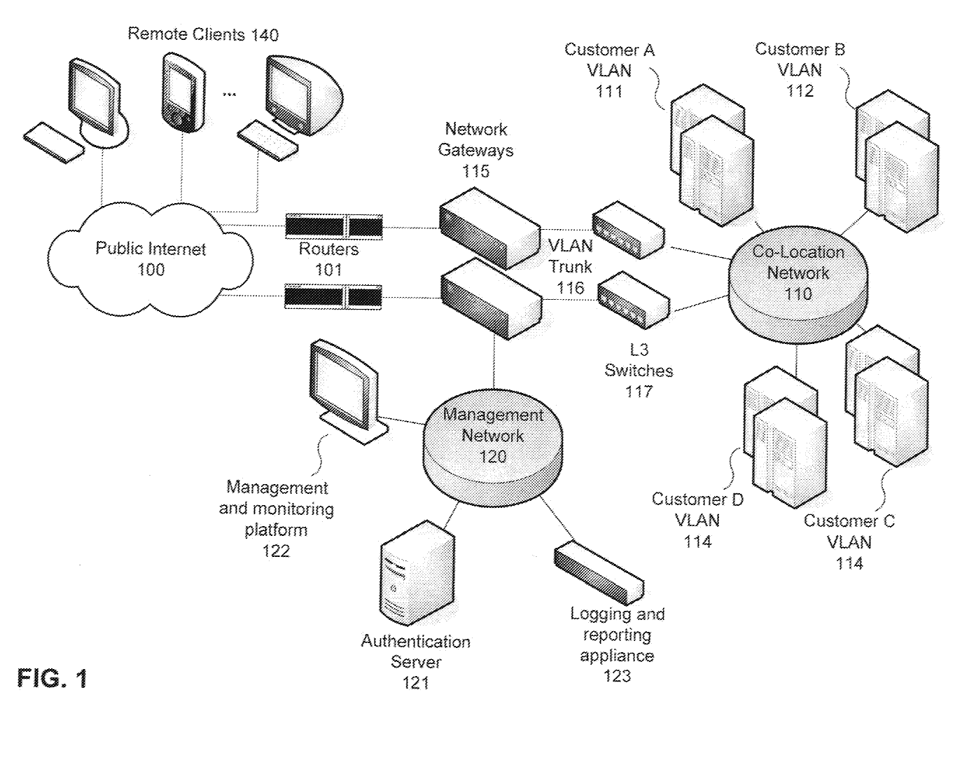

FIG. 1 illustrates an example Managed Security Service Provider (MSSP) environment in which various embodiments of the present invention may be implemented. By way of background, an MSSP is typically an ISP that provides an organization with some amount of network security management, which may include virus blocking, spam blocking, intrusion detection, firewalls, and virtual private network (VPN) management. MSSPs have evolved in various ways. Some traditional Internet Service Providers (ISPs), noting the increasing demand for Internet security, have added managed security to their service offerings. Meanwhile, some security vendors have added Internet access, thus becoming MSSPs. Still other MSSPs have come into existence as brand new entities. A competent MSSP offers cost savings by allowing an organization to outsource its security functions as the MSSP can efficiently handle system changes, modifications, and upgrades on behalf of a large number of customers.

In accordance with the present example, a co-location network 110 is coupled in communication with the public Internet 100 through one or more intermediate networking devices, such as routers 101, network gateways 115 and layer 3 (L3) switches 117. Each subscriber has a corresponding virtual local area network (VLAN) (i.e., Customer A VLAN 111, Customer B VLAN 112, Customer C VLAN 113 and Customer D VLAN 114) within the co-location network 110 with which the customer's telecommunications and/or network equipment is associated. Consequently, end users of subscribers of the MSSP may access the pubic Internet 100 from their respective VLANs by way of the intermediate devices or end users may access various services and data provided by co-location network 110 by way of remote clients 140 connected to the public Internet 100.

In one embodiment of the present invention and as described in further detail below, the network gateways 115 include authentication-based routing logic to both authenticate end users of the subscribers and maintain logical separation among the subscribers. For example, the network gateways 115 may intercept connection attempts originating from clients, such as remote clients 114, associated with the subscriber VLANs and establish service sessions by creating routing entries for authenticated end users based on one or more authentication attributes associated with successful authentication responses from an authentication server, such as authentication server 121. In the context of the present example, subsequent packets associated with a particular authenticated end user's service session may then be forwarded to the appropriate VLAN via an interface of the network gateway associated with that VLAN.

In one embodiment, the network gateways 115 may be one of the FortiGate™ multi-threat security systems, such as the FortiGate-5000 Series, FortiGate-3000 or FortiGate-3600A multi-threat security systems, or one of the FortiGate™ Enterprise Series antivirus firewalls, such as the FortiGate-400, 400A, 500, 500A, and 800 Antivirus Firewall models.

The co-location network 110 may be managed by personnel of the MSSP via a management network 120. In the present example, the management network 120 includes an authentication server 121, a management and monitoring platform 122 and a logging and reporting appliance 123.

According to one embodiment, the authentication server 121 comprises a RADIUS server and an augmented RADIUS database supplemented to include information intended to be used to facilitate routing of subscriber traffic flows by the network gateways 115 to appropriate VLANs. In one embodiment, an authentication database may be augmented to include a VLAN name, a VDOM name and/or an interface name that can be used by the network gateways 115 to identify an appropriate physical interface onto which to forward traffic of an authenticated end user. In alternative embodiments, authentication may be performed by various other means, including, but not limited to a directory access protocol-based authentication protocol, such as Lightweight Directory Access Protocol (LDAP), a Terminal Access Controller Access Control System (TACACS) authentication protocol, such as Terminal Access Controller Access Control System (TACACS), extended TACACS (XTACACS), TACACS+ or a successor to RADIUS, such as Diameter.

The management and monitoring platform 122 may provide personnel of the MSSP with a central management solution for deploying, provisioning, configuring, maintaining and otherwise managing and monitoring of the network gateways and resources associated with the co-location network 110. In one embodiment, the management and monitoring platform 112 comprises a FortiManager™ management and monitoring platform, such as FortiManager-100, FortiManager-400A or FortiManager-3000, available from Fortinet, Inc. of Sunnyvale, Calif.

The logging and reporting appliance 123 logs, gathers, correlates, analyzes and stores event data from across the co-location network architecture and provides a reporting architecture that facilitates report creation by personnel, such as information technology (IT) administrators, of the MSSP. The reporting capabilities of the logging and reporting appliance 123 may encompass many types of traffic including one or more of network, Web, FTP, Terminal, Mail, Intrusion, Antivirus, Web Filter, Mail Filter, VPN and Content. The logging and reporting appliance 123 may also provide advanced logging with meta content logs to facilitate with regulatory compliance, such as the Health Insurance Portability and Accountability Act (HIPAA) and Sarbanes-Oxley (SOX), by allowing high-level monitoring of HTTP, FTP, IMAP, POP3 and SMTP traffic from the network gateways 115 and/or resources associated with the co-location network 110. In one embodiment, the logging and reporting appliance 123 comprises one of the FortiAnalyzer™ family of real-time network logging, analyzing and reporting systems, such as the FortiAnalyzer-100B, 400, 800, 2000 or 4000A models, available from Fortinet, Inc. of Sunnyvale, Calif.

While for purposes of illustration a co-location network based architecture has been described above, it will be understood by those skilled in the art that the authentication-based routing methodologies described herein are applicable to various other network architectures and MSSP models.

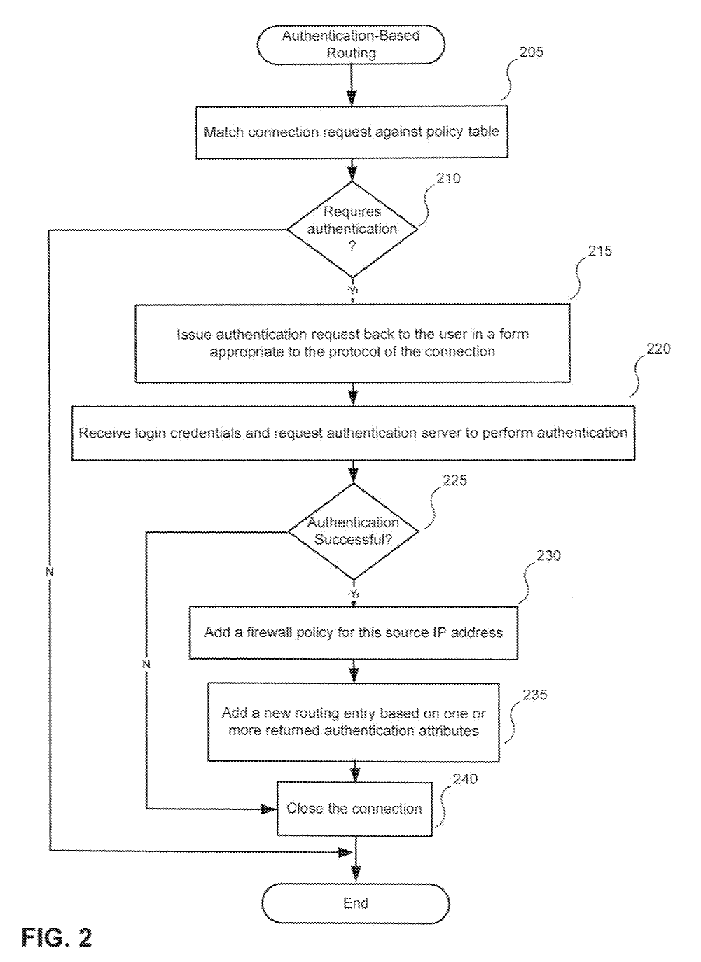

FIG. 2 is a simplified, high-level flow diagram illustrating an authentication procedure for a dynamic policy routing according to one embodiment of the present invention. The blocks of the flow diagram generally represent code that may be stored in the RAM 315 or the ROM 320 for directing the processor(s) 305 to carry out an authentication process. The actual code to implement each block may be written in any suitable high- or low-level programming language or scripting language, such as C, C++, assembly language, Perl, shell, PHP and the like. The blocks of the flow diagram may also represent functionality implemented by a combination of hardware, software, firmware and/or by human operators.

According to the present example, during authentication with a customer's authentication server (e.g., RADIUS, LDAP, AD etc.) one or more authentication attributes may be returned by the authentication server to facilitate routing of an end user traffic flow. For example, information regarding a destination virtual network, such as a destination VLAN or a destination virtual domain can be returned by the authentication server and then used by a network device, such as one of network gateways 115, to install a policy route from the client's source IP address to the desired virtual network.

Another possibility is that the authentication server returns a group name that the authenticated user belongs to and the gateway includes a predefined mapping table between the customer's user groups and a set of virtual networks (e.g., gateway virtual domains or VLANs). When authentication happens, the gateway would then use the received user group to lookup a desired virtual network and could then install a policy route from the client's source IP address to the virtual network found in the translation table.

Returning to the present example, a firewall running within a gateway, such as one of network gateways 115, is assumed to be monitoring connection attempts to a managed service. The gateway authentication-based routing procedure begins at block 205 after a user connection request has been received. At block 205, the connection request is matched against a policy table to determine, based on the nature of the network traffic (e.g., source/destination IP/port, protocol, etc.), an action to be taken (e.g., allow traffic, block traffic, require authentication).

At decision block 210, if the policy indicates authentication is required for the particular user connection, then processing proceeds to block 215. Otherwise, no further action is required and the authentication-based routing process terminates. For example, in the case of a connection that must be blocked, no authentication is required and the gateway may drop the connection request without informing the end user. In the case of a connection that is allowed without authentication, the gateway forwards the connection request to its destination without need for further authentication-based routing processing.

At block 215, a connection requiring authentication is being processed. Consequently, the user connection request is accepted and responsive to the connection request, the gateway sends an authentication request back to the user in a form appropriate to the protocol of the connection. For example, in the context of an HTTP or HTTPS connection, the gateway may send back a web page that will be recognized by the user's browser prompting the user to input his/her login credentials (e.g., a user name and password). For Telnet, the gateway may request the username and password sequentially, using ASCII characters, in the same fashion as typical Telnet servers. For FTP, the gateway may request login credentials in accordance with standard FTP authentication commands as described in Request for Comments (RFC) 959. Notably, various other authentication credentials may be used, such as passphrases, smart cards, Personal Identification Numbers (PINs), tokens, biometrics, certificates and the like. The present invention is not limited to any particular type of authentication or authentication credentials.

According to the present example, the gateway waits to receive the login credentials before the user can obtain access to the managed service. At block 220, the gateway receives the login credentials, e.g., user name and password, and initiates an authentication process to verify the user is an authorized user of the managed service. In one embodiment, user authentication involves interaction with one or more third-party RADIUS servers. For example, the gateway may send a RADIUS Access-Request to an appropriate RADIUS server associated with the managed service attempting to be accessed by the user. The Access-Request may include one or more of the following attributes:
User-Name: the user's username within the context of the managed service.
User-Password: the password associated with the username
NAS-Identifier: the gateway's hostname
NAS-IP-Address: the IP address of the physical interface of the user's incoming request
NAS-Port: the index of the physical interface of the user's incoming request
Called-Station-ID: same as NAS-IP-Address
Acct-Session-ID: a unique number to identify this current session
Content-Info: the name of the authenticating service (IPSec, web-auth, pptp, . . . ; web-auth in this case).
Vdom-Name: a Vendors-Specific attribute (VSA) indicating the name of the virtual domain associated with the user's incoming request.

The RADIUS protocol is described in RFC 2865 (http://rfc.net/rfc2865.html), which is hereby incorporated by reference for all purposes.

At decision block 225, the gateway waits for the authentication result from the authentication process. In the case of RADIUS authentication, the RADIUS server verifies the username/pas sword and returns a RADIUS Access-Accept or Access-Reject response indicating success or failure, respectively. Upon receipt of the authentication result, a determination is made by the gateway regarding whether the authentication was successful. In the case of RADIUS authentication, this determination can be made based on the type of response packet received, i.e. an Access-Accept packet vs. an Access-Reject packet. By default, end user traffic is routed to the same link interface on which the original connection request arrived. If the authentication is unsuccessful, the destination link interface to which the end user's traffic is routed remains unchanged, the user is denied access through the gateway and processing branches to block 240. If the authentication is successful, processing continues with block 230.

At block 230, the gateway adds a firewall policy specifically for the source IP address associated with the now authenticated user thereby granting the user access through the gateway.

At block 235, a specific routing entry may be created within the gateway for the authenticated user's source IP address. According to one embodiment, in the context of RADIUS authentication, successful authentication may involve the RADIUS server returning information regarding a logical or physical interface of the gateway or information regarding a virtual network to facilitate subsequent routing of traffic flows associated with the authenticated user to an appropriate virtual network which the authenticated user is associated by virtue of his/her affiliation with the subscriber. For example, successful authentication by a RADIUS server may cause the RADIUS server to return an interface name, a VLAN identifier, a VLAN name or a VDOM name within a Vendor-Specific attribute (VSA) of the RADIUS Access-Accept response packet. The value of the VSA provided in the RADIUS Access-Accept response packet may then be used to establish a routing entry to forward traffic from the user's source IP address to a gateway interface associated with an identified destination VLAN, for example.

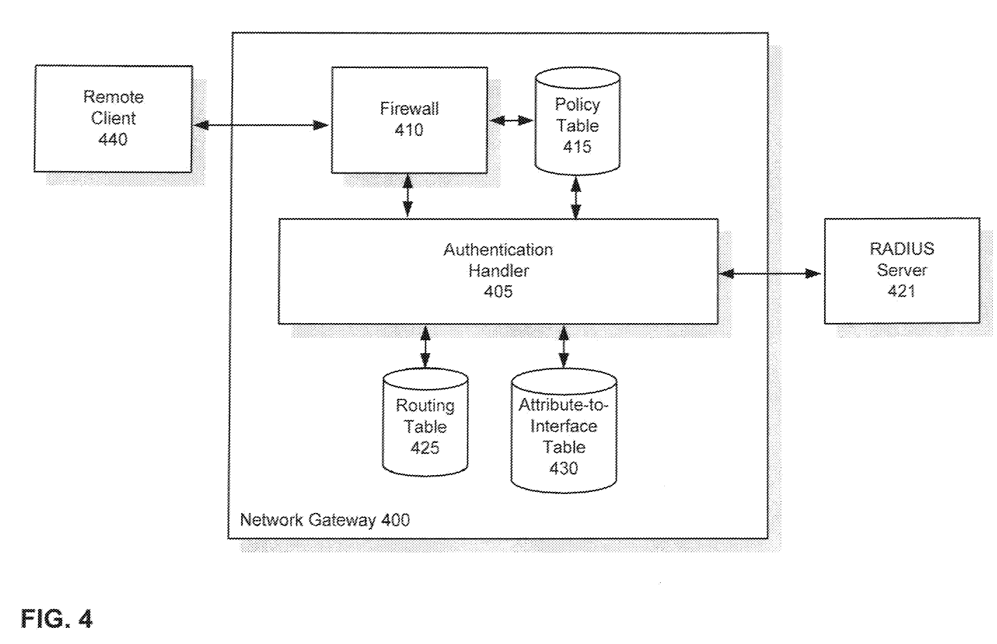

Notably, there are many other ways of using the one or more VSAs (e.g., Interface-Name, VLAN-id, VLAN-name, Vdom-Name, etc.) that might be returned with the authentication result. In alternative embodiments, instead of using a VLAN per customer, there might be just one VLAN. Or, instead of a policy route, a regular route could be used. Additionally, in various embodiments, the RADIUS server might return to the gateway either exact information about a destination VLAN, or it might return some kind of reference that may be processed further by the gateway to obtain the VLAN. For example, the information returned in the VLAN-Name attributed may be used to look up the VLAN in a local translation table, such as the attribute-to-interface table 430 discussed below with reference to FIG. 4.

At block 245, the connection is closed. If authentication was successful, subsequent traffic from the source IP address associated with the authenticated user will be forwarded to the VLAN identified based on the authentication response.

### Network Device Overview

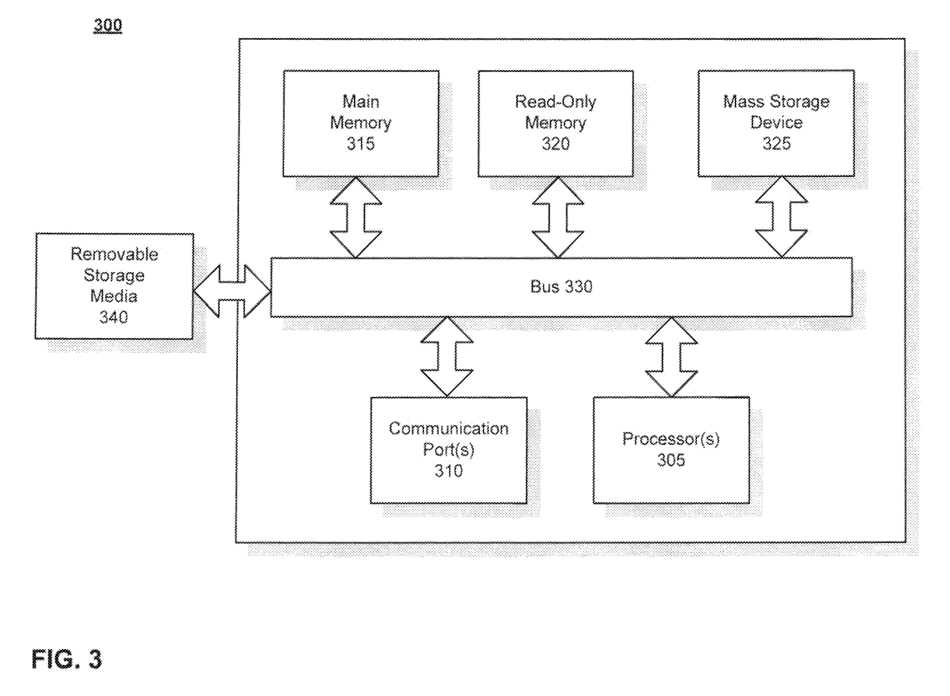

An exemplary machine in the form of a network device 300, representing an exemplary network device, edge appliance, firewall, gateway or the like in which features of the present invention may be implemented will now be described with reference to FIG. 3. In this simplified example, the network device 300 comprises a bus or other communication means 330 for communicating information, and a processing means such as one or more processors 305 coupled with bus 330 for processing information. Networking device 300 further comprises a random access memory (RAM) or other dynamic storage device 315 (referred to as main memory), coupled to bus 330 for storing information and instructions to be executed by processor(s) 305. Main memory 315 also may be used for storing temporary variables or other intermediate information during execution of instructions by processor(s) 305. Network device 300 also comprises a read only memory (ROM) and/or other static storage device 320 coupled to bus 330 for storing static information and instructions for processor 305. Optionally, a data storage device (not shown), such as a magnetic disk or optical disc and its corresponding drive, may also be coupled to bus 330 for storing information and instructions.

The network device may also include a media interface (not shown) to facilitate loading of program codes into the ROM 320 or the RAM 315 from a computer readable medium (not shown), such as a CD ROM, or from a computer readable signal (not shown), such as provided by an Internet connection, for directing the processor(s) 305 to carry out functions according to a method associated with one or more aspects of the invention.

One or more communication ports 310 may also be coupled to bus 330 for allowing various local terminals, remote terminals and/or other network devices to exchange information with or though the network device 300 by way of a Local Area Network (LAN), Wide Area Network (WAN), Metropolitan Area Network (MAN), the Internet, or the public switched telephone network (PSTN), for example. The communication ports 310 may include various combinations of well-known interfaces, such as one or more modems to provide dial up capability, one or more 10/100 Ethernet ports, one or more Gigabit Ethernet ports (fiber and/or copper), or other well-known interfaces, such as Asynchronous Transfer Mode (ATM) ports and other interfaces commonly used in existing LAN, WAN, MAN network environments. In any event, in this manner, the network device 300 may be coupled to a number of other network devices, clients and/or servers via a conventional network infrastructure, such as a company's Intranet and/or the Internet, for example.

Optionally, operator and administrative interfaces (not shown), such as a display, keyboard, and a cursor control device, may also be coupled to bus 330 to support direct operator interaction with network device 300. Other operator and administrative interfaces can be provided through network connections connected through communication ports 310.

Finally, removable storage media 340, such as one or more external or removable hard drives, tapes, floppy disks, magneto-optical discs, compact disk-read-only memories (CD-ROMs), compact disk writable memories (CD-R, CD-RW), digital versatile discs or digital video discs (DVDs) (e.g., DVD-ROMs and DVD+RW), Zip disks, or USB memory devices, e.g., thumb drives or flash cards, may be coupled to bus 330 via corresponding drives, ports or slots.

FIG. 4 is a block diagram conceptually illustrating interaction among various functional units of a network gateway 400 with a remote client 440 and a RADIUS server 421 in accordance with one embodiment of the present invention. According to the present example, the network gateway 400 includes a firewall 410, a policy table 415, an authentication handler 405, a routing table 425 and an attribute-to-interface table 430.

In one embodiment, the remote client 440 sends a connection request that is intercepted by the firewall 410. The firewall 410 may represent a set of one or more programs executing on the network gateway 400 that serves to enforce various security policies and protect the resources of a private network, such as co-location network 110, from unauthorized users. According to one embodiment, the firewall 410 matches the intercepted connection request from the remote client 440 against the policy table 415 to determine whether to allow, block or authenticate the connection request.

The routing table 425 contains a set of rules that are used to determine where data packets originated by the remote client 440 will be directed. According to one embodiment the routing table entries (not shown) of the routing table 425 include at least a destination field, identifying the IP address of the packet's final destination, a next hop field, identifying the IP address to which the packet is to be forwarded, and an interface field, identifying the outgoing network interface of the network gateway 400 that should be used when forwarding the packet to the next hop or the final destination.

According to one embodiment, the attribute-to-interface table 430 represents a mapping of attribute values (e.g., VLAN-name, VLAN-id, Vdom-name, interface-name, etc.) that may be returned with successful authentication responses to corresponding network interfaces of the network gateway 400.

According to the present example, the authentication handler 405 interacts with each of the firewall 410, the policy table 415, the routing table 425, the attribute-to-interface table 430 and the RADIUS server 421. In one embodiment, responsive to the firewall 410 indicating to the authentication handler 405 that the current connection request requires authentication, the authentication handler 405 issues an authentication request to the remote client 440 in a form appropriate to the protocol of the current connection.

In the context of the present example, login credentials received by the authentication handler 405 from the remote client 440 are relayed to the RADIUS server 421 as part of an authentication process to verify whether the user of the remote client 440 is authorized to make the requested connection. When the user of the remote client 440 is successfully authenticated by the RADIUS server 421, the authentication handler 405 uses the authentication result to update the policy table 415 to include a firewall policy corresponding to the source IP address of the authenticated remote client 440. The authentication handler 405 may also create a new routing entry in the routing table 425 responsive to successful authentication. In one embodiment, the authentication handler 405 uses the attribute-to-interface table 430 to facilitate creation of the new routing entry by mapping a VSA returned in a RADIUS Access-Accept response packet to a logical or physical interface of the network gateway 400.

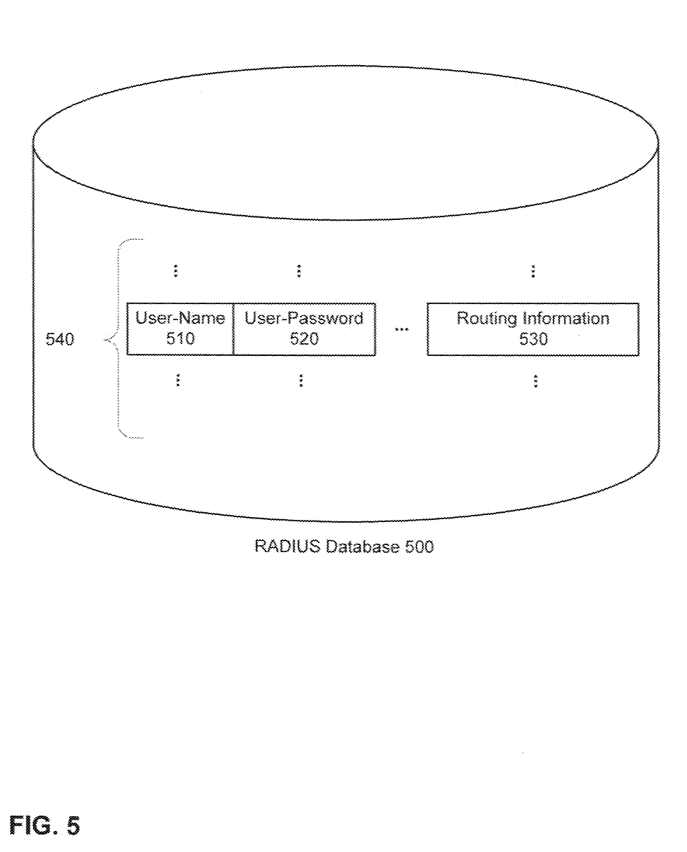

The RADIUS server 421 operates in a manner consistent with RFC 2865. Importantly, however, a RADIUS database (not shown) associated with the RADIUS server 421 is augmented to include information intended to be used to facilitate routing of traffic flows associated with one or more virtual networks as described further below with reference to FIG. 5. In one embodiment, the RADIUS server 421 may return values within one or more VSAs that directly or indirectly identify a virtual network (e.g., a VLAN or a VDOM) onto which to forward the authenticated traffic flow.

While in the context of the present example, authentication via intercepted connection attempts is described, various alternatives are available. For example, users of the co-location network 110, such as user of remote client 440, may be required to explicitly initiate a connection to the network gateway 400 for the purpose of authenticating. The protocols used for this purpose could be the same as described above, but could also involve any other protocols that allow passing credentials between the user and the network gateway 400.

FIG. 5 is a block diagram conceptually illustrating a simplified RADIUS database 500 in accordance with one embodiment of the present invention. In this simplified example, the RADIUS database 500 includes authentication entries 540, a subset of attributes (i.e., User-Name 510, User-Password 520 and Routing Information 530) of one of which is shown for purposes of explanation.

The User-Name attribute 510 indicates the name of the user to be authenticated. The User-Password attribute 520 indicates the password of the user to be authenticated stored in an encrypted format in accordance with RFC 2865. According to one embodiment, each authentication entry of the RADIUS database 500 is augmented to include a Vendor-Specific attribute, such as routing information 530, which facilitates routing of user traffic flows to appropriate virtual networks. In one embodiment, the routing information 530 may represent a name of a VLAN or a VLAN identifier. In other embodiments, the routing information 530 may represent a VDOM name. Alternatively, the routing information 530 may identify a logical or physical interface of a network gateway, such as one of network gateways 115 or network gateway 400, onto which traffic from the corresponding user, identified by the User-Name attribute 510, should be forwarded.

According to one embodiment, when a RADIUS server, such as RADIUS server 421, receives a RADIUS Access-Request (not shown), it authenticates the user by matching the User-Name and the User-Password attributes in the RADIUS Access-Request (as appropriately transformed in accordance with RCF 2865) against the RADIUS database 500. If a matching authentication entry is found, then the RADIUS server responds to the requestor with a RADIUS Access-Accept packet including the routing information 530. In this manner, information returned with the successful authentication of a user may be used to create routing entries which indicate how to route traffic flow from the authenticated user during the remainder of the session.

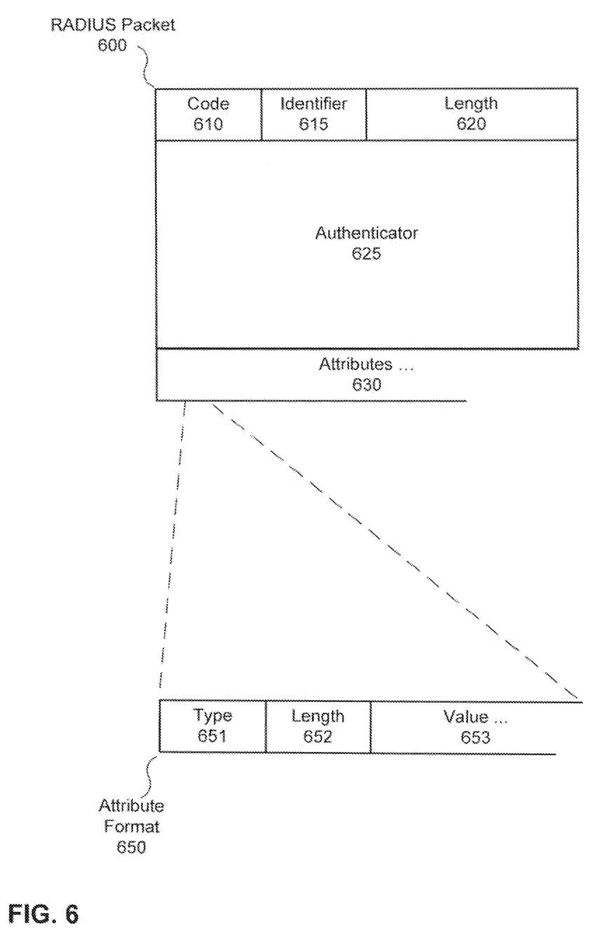

FIG. 6 is a block diagram conceptually illustrating a RADIUS packet 600 and attribute format 650. The RADIUS packet 600 includes a code 610, an identifier 615, a length 620, an authenticator 625 and one or more attributes 630. The code field 610 identifies the type of RADIUS packet. The value of a code field 610 of a RADIUS Access-Request packet is 1. The value of a code field 610 of a RADIUS Access-Accept packet is 2. Other values are specified in RFC 2865.

The identifier field 615 is used by the RADIUS protocol to match requests and replies. A RADIUS server can detect a duplicate request if it has the same client source IP address and source User Datagram Protocol (UDP) port and identifier field value within a short span of time.

The length field 620 indicates the length of the packet including the code field 610, the identifier field 615, the length field 620, the authenticator field 625 and attribute fields 630.

The authenticator field 625 of the RADIUS packet 600 contains a value that is used to authenticate the reply from the RADIUS server, and is used in the password hiding algorithm as specified in RFC 2865.

One or more attributes may be provided in the attribute field 630 formatted in accordance with the attribute format 650. The attribute format 650, includes a type 651, a length 652 and a value 653. The type field 651, length field 652 and optional value field(s) 653 may be repeated as constrained by the length 620 of the RADIUS packet 600. The value of the type field 651 identifies the attribute type of the current attribute. For example, the type field 651 of a User-Name attribute is set to 1. The type field 651 of a User-Password attribute is set to 2. The type field 651 of a Vendor-Specific attribute (VSA) is set to 26. Further information regarding the format of a VSA is well documented in RFC 2865, which has earlier been incorporated by reference herein.

The length field 652 indicates the length of the current attribute including the type field 651, the length field 652 and the value fields 653.

The value fields 653 represent zero or more octets of information specific to the current attribute. For example, in the context of a Vdom-Name VSA returned by a RADIUS server in a RADIUS Access-Accept packet, the value may be text or a string of binary data encoding the name of a VDOM, such as “subscriber 1 vdom,” onto which traffic originating from the authenticated user should be forwarded. Similarly, in the context of a VLAN-Name VSA, the value may be text or a string encoding the name of a VLAN to which traffic originating from the authenticated user should be sent during the session. A network gateway receiving the routing information 530 returned by way of a VSA of a RADIUS packet may use the information to directly or indirectly, by way of a translation table, such as attribute-to-interface table 430, identify a network interface onto which traffic flow associated with the authenticated user should be routed for the duration of the session.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A system comprising:
an authentication server having an augmented authentication database including routing information for each of a plurality of users, the routing information for use in connection with facilitating routing of traffic flows associated with the plurality of users to appropriate virtual networks of a plurality of virtual networks associated with a network accessible by the plurality of users; and
a network, including a network device fronting the network and coupled in communication with the authentication server, the network device including:
a storage device having stored therein one or more authentication handler routines operable to authenticate users of the plurality of users and establish appropriate service connections for authenticated users; and
one or more processors coupled to the storage device and operable to execute the one or more authentication handler routines, where
login credentials of a user of the plurality of users are authenticated against the augmented authentication database responsive to receiving, by the one or more authentication handler routines, a request on behalf of the user to access a service provided by a first virtual network of the plurality of virtual networks,
responsive to successful authentication of the login credentials, routing information associated with the authenticated user is received from the authentication server by the one or more authentication handler routines; and
a connection to the service is established for the authenticated user by creating a routing entry within a routing table of the network device based on the received routing information.

2. The system of claim 1, wherein the network device comprises a network gateway.

3. The system of claim 1, wherein the authentication server comprises a Remote Authentication Dial-in User Service Protocol (RADIUS) server.

4. The system of claim 1, wherein the plurality of virtual networks comprise virtual local area networks (VLANs).

5. The system of claim 1, wherein the authentication server communicates with the network device via a Terminal Access Controller Access Control System (TACACS) authentication protocol.

6. The system of claim 1, wherein the authentication server communicates with the network device via a directory access protocol-based authentication protocol.

7. The system of claim 1, wherein the network comprises a public network.

8. The system of claim 1, wherein the network comprises a private network.

9. A program storage device readable by a network device associated with a service provider, tangibly embodying a program of instructions executable by one or more processors of the network device to perform method steps for authenticating users and establishing appropriate service sessions for authenticated users, said method steps comprising:
receiving a connection request from an end user of one of a plurality of customers for which the service provider delivers services;
causing the end user to be prompted for login credentials;
responsive to receiving the login credentials, requesting authentication of the login credentials by an authentication server;
responsive to receiving an indication of successful authentication of the login credentials from the authentication server, establishing a service session for the end user and maintaining customer separation among the plurality of customers by creating a routing entry corresponding to an address associated with the connection request based on one or more authentication attributes associated with the indication and routing subsequent packets associated with the service session in accordance with the routing entry.

10. The program storage device of claim 9, wherein said receiving a connection request comprises intercepting a connection request directed to a server for which the network device is fronting.

11. The program storage device of claim 9, wherein said authentication server comprises a Remote Authentication Dial-in User Service Protocol (RADIUS) server.

12. The program storage device of claim 11, wherein the RADIUS server includes an augmented authentication database including information for use in connection with facilitating routing of traffic flows to appropriate virtual local area networks (VLANs) with which the plurality of customers are associated.

13. The program storage device of claim 12, wherein the information comprises a VLAN name.

14. The program storage device of claim 13, wherein the indication comprises a RADIUS Access-Accept packet including an attribute field and wherein the RADIUS Access-Accept packet contains the VLAN name within a VLAN attribute of the attribute field.

15. The program storage device of claim 11, wherein the RADIUS server includes an augmented authentication database including information for use in connection with facilitating routing of traffic flows to appropriate virtual domains (VDOMs) with which the plurality of customers are associated.

16. The program storage device of claim 11, wherein the RADIUS server includes an augmented authentication database including information for use in connection with facilitating routing of traffic flows to appropriate interfaces of the network device with which the plurality of customers are associated.

17. The program storage device of claim 16, wherein the information comprises an interface name.

18. The program storage device of claim 17, wherein the indication comprises a RADIUS Access-Accept packet including an attribute field and wherein the RADIUS Access-Accept packet contains the interface name within an interface name attribute of the attribute field.

19. The program storage device of claim 9, wherein said requesting authentication of the login credentials by an authentication server comprises the network device issuing an authentication request via a Terminal Access Controller Access Control System (TACACS) authentication protocol or issuing an authentication request via a directory access protocol-based authentication protocol.

20. The program storage device of claim 9, wherein the network device comprises a network gateway or a firewall.

21. The program storage device of claim 9, where said creating a routing entry comprises:
determining a physical interface of the network device to which the subsequent packets are to be forwarded based on the one or more attributes;
creating a routing entry that associates a source Internet Protocol (IP) address of the end user with the physical interface.

22. The program storage device of claim 9, wherein the services are delivered to the plurality of customers from a co-location network fronted by the network device.

23. The program storage device of claim 9, wherein the services comprise network security management including one or more of virus blocking, spam blocking, intrusion detection, firewalls, and virtual private network (VPN) management.

24. The program storage device of claim 9, wherein a protocol of the connection request comprises HyperText Transport Protocol (HTTP), HyperText Transfer Protocol, Secure (HTTPS), Telnet or File Transfer Protocol (FTP).
